(19) United States
(12) Patent Application Publication
(10) Pub. No.: US 2026/0061835 A1
(43) Pub. Date: Mar. 5, 2026

(54) HIGH PRESSURE TANK SYSTEM AND MOVING BODY

(71) Applicant: HONDA MOTOR CO., LTD., TOKYO (JP)

(72) Inventor: Satoru KAWASE, WAKO-SHI (JP)

(21) Appl. No.: 19/312,815

(22) Filed: Aug. 28, 2025

(30) Foreign Application Priority Data
Sep. 3, 2024 (JP) 2024-151628

(51) Int. Cl. B60K 15/07; B60K 15/03; F17C 13/00; F17C 13/08

(52) U.S. Cl. CPC B60K 15/07; F17C 13/002; F17C 13/084; B60K 2015/03144; F17C 2205/0142; F17C 2221/012; F17C 2270/0168; F17C 2270/0184

(57) ABSTRACT

A high pressure tank system is equipped with a group of high pressure tanks having a plurality of cylindrically shaped high pressure tanks that are filled with a fuel gas that is supplied to a motive power source, an accommodation unit in which the group of high pressure tanks are accommodated, and a discharge flow path through which a discharged gas that is guided from the motive power source flows. The accommodation unit is provided with the discharge flow path, and the discharge flow path is disposed in a manner so that heat of the discharged gas flowing through the discharge flow path is transferable to the group of high pressure tanks.

### CROSS-REFERENCE TO RELATED APPLICATIONS

This application is based upon and claims the benefit of priority from Japanese Patent Application No. 2024-151628 filed on Sep. 3, 2024, the contents of which are incorporated herein by reference.

### BACKGROUND OF THE INVENTION

### Field of the Invention

The present disclosure relates to a high pressure tank system and a moving body.

### Description of the Related Art

In recent years, in order to make it possible for more people to ensure access to affordable, reliable, sustainable, and advanced energy, research and development have been conducted in relation to a high pressure tank system and a moving body that contribute to energy efficiency.

In JP 7067241 B2, a fuel cell vehicle (a moving body) is disclosed which is equipped with a high pressure tank system. The high pressure tank system includes a plurality of high pressure tanks which are filled with a hydrogen gas (a fuel gas) that is supplied to a fuel cell stack (a motive power source). An axis direction of each of the high pressure tanks extends in a first direction that is directed along a horizontal direction. The plurality of high pressure tanks are arranged in a second direction that is perpendicular to the first direction and directed along the horizontal direction.

### SUMMARY OF THE INVENTION

There is a long-awaited need for an improved high pressure tank system and an improved moving body.

The present disclosure has the object of satisfying the aforementioned need.

A first aspect of the present disclosure is characterized by a high pressure tank system, including a group of high pressure tanks including a plurality of high pressure tanks each having a cylindrical shape, the high pressure tanks being configured to be filled with a fuel gas that is supplied to a motive power source, an accommodation unit configured to accommodate the group of high pressure tanks, and a discharge flow path through which a discharged gas that is guided from the motive power source flows, wherein the accommodation unit is provided with the discharge flow path, and the discharge flow path is disposed in a manner so that heat of the discharged gas flowing through the discharge flow path is transferable to the group of high pressure tanks.

A second aspect of the present disclosure is characterized by a high pressure tank system, including a group of high pressure tanks including a plurality of high pressure tanks each having a cylindrical shape, the high pressure tanks being configured to be filled with a fuel gas that is supplied to a motive power source, an accommodation unit configured to accommodate the group of high pressure tanks, and a discharge flow path through which a discharged gas that is guided from the motive power source flows, wherein the discharge flow path is disposed in a manner so that heat of the discharged gas flowing through the discharge flow path is transferable to the group of high pressure tanks, an axis line of each of the plurality of high pressure tanks extends in a first direction that is directed along a horizontal direction, the plurality of high pressure tanks are arranged in a second direction that is perpendicular to the first direction and directed along the horizontal direction, the accommodation unit includes a side wall portion configured to cover the group of high pressure tanks from the second direction, the side wall portion is provided with the discharge flow path, and the group of high pressure tanks includes a first group of high pressure tanks and a second group of high pressure tanks that are disposed mutually adjacent to each other in an upward/downward direction, wherein the side wall portion includes a first portion configured to cover the first group of high pressure tanks from the second direction, and a second portion adjacent to the first portion in the upward/downward direction, and configured to cover the second group of high pressure tanks from the second direction, and wherein the second portion includes the discharge flow path, and the first portion projects out with respect to the second portion toward an opposite side to the group of high pressure tanks.

A third aspect of the present disclosure is characterized by a high pressure tank system, including a group of high pressure tanks including a plurality of high pressure tanks each having a cylindrical shape, the high pressure tanks being configured to be filled with a fuel gas that is supplied to a motive power source, an accommodation unit configured to accommodate the group of high pressure tanks, and a discharge flow path through which a discharged gas that is guided from the motive power source flows, wherein the discharge flow path is disposed in a manner so that heat of the discharged gas flowing through the discharge flow path is transferable to the group of high pressure tanks, an axis line of each of the plurality of high pressure tanks extends in a first direction that is directed along a horizontal direction, the plurality of high pressure tanks are arranged in a second direction that is perpendicular to the first direction and directed along the horizontal direction, the discharge flow path includes a lower-side discharge flow path disposed downwardly of the group of high pressure tanks, and a lower-side heat insulating member is disposed between the group of high pressure tanks and the lower-side discharge flow path.

A fourth aspect of the present disclosure is characterized by a high pressure tank system, including a group of high pressure tanks including a plurality of high pressure tanks each having a cylindrical shape, the high pressure tanks being configured to be filled with a fuel gas that is supplied to a motive power source, an accommodation unit configured to accommodate the group of high pressure tanks, and a discharge flow path through which a discharged gas that is guided from the motive power source flows, wherein the discharge flow path is disposed in a manner so that heat of the discharged gas flowing through the discharge flow path is transferable to the group of high pressure tanks, an axis line of each of the plurality of high pressure tanks extends in a first direction that is directed along a horizontal direction, the plurality of high pressure tanks are arranged in a second direction that is perpendicular to the first direction and directed along the horizontal direction, the discharge flow path includes an upper-side discharge flow path disposed upwardly of the group of high pressure tanks, and an upper-side heat insulating member is disposed between the group of high pressure tanks and the upper-side discharge flow path.

A fifth aspect of the present disclosure is characterized by a moving body including the high pressure tank system according to any one of the first to fourth aspects, and the motive power source.

According to the present disclosure, a more satisfactory high pressure tank system and a more satisfactory moving body can be provided.

The above and other objects, features, and advantages of the present invention will become more apparent from the following description when taken in conjunction with the accompanying drawings, in which preferred embodiments of the present invention are shown by way of illustrative example.

### BRIEF DESCRIPTION OF THE DRAWINGS

FIG. 1 is a schematic diagram showing a moving body equipped with a high pressure tank system;

FIG. 2 is a schematic cross-sectional view taken along line II-II of FIG. 1;

FIG. 3 is a schematic diagram of a high pressure tank system according to a first exemplary modification;

FIG. 4 is a schematic cross-sectional view of a high pressure tank system according to a second exemplary modification;

FIG. 5 is a schematic cross-sectional view of a high pressure tank system according to a third exemplary modification;

FIG. 6 is a schematic diagram of a high pressure tank system according to a fourth exemplary modification;

FIG. 7 is a schematic cross-sectional view taken along line VII-VII of FIG. 6; and

FIG. 8 is a schematic cross-sectional view of a high pressure tank system according to a fifth exemplary modification.

### DETAILED DESCRIPTION OF THE INVENTION

In the case that a fuel gas is supplied from the high pressure tanks to the motive power source, the temperature of the fuel gas decreases due to adiabatic expansion of the fuel gas. When a low temperature fuel gas is supplied to the motive power source, it may have an adverse influence on the durability of seals in auxiliary components or the like. Furthermore, in the aforementioned JP 7067241 B2, there is no disclosure concerning a discharge flow path through which a discharged gas from the fuel cell stack, which is the motive power source, is guided. According to the present disclosure, it is possible to provide a high pressure tank system and a moving body which are capable of preventing the low temperature fuel gas from being supplied to the motive power source.

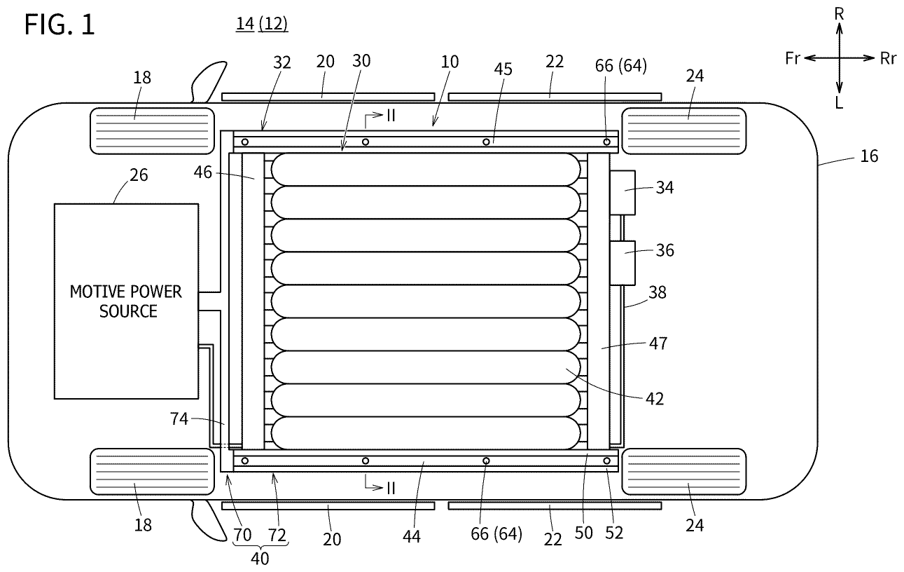

FIG. 1 is a schematic diagram showing a moving body 12 equipped with a high pressure tank system 10. As shown in FIG. 1, in the present embodiment, the moving body 12 is a vehicle 14 such as a fuel cell vehicle or the like. The moving body 12 is an object that possesses mobility, and is not necessarily limited to being the vehicle 14. The moving body 12 may be, for example, an aircraft such as an electric vertical takeoff and landing aircraft (eVTOL), a drone, or the like. Further, the high pressure tank system 10 is not necessarily limited to being mounted on the moving body 12. The high pressure tank system 10 may also be applied to a stationary fuel cell system.

In the present embodiment, in the vehicle 14 shown in FIG. 1, the “Fr direction” may be referred to as a “frontward direction”, the “Rr direction” may be referred to as a “rearward direction”, the “L direction” may be referred to as a “leftward direction”, and the “R direction” may be referred to as a “rightward direction”.

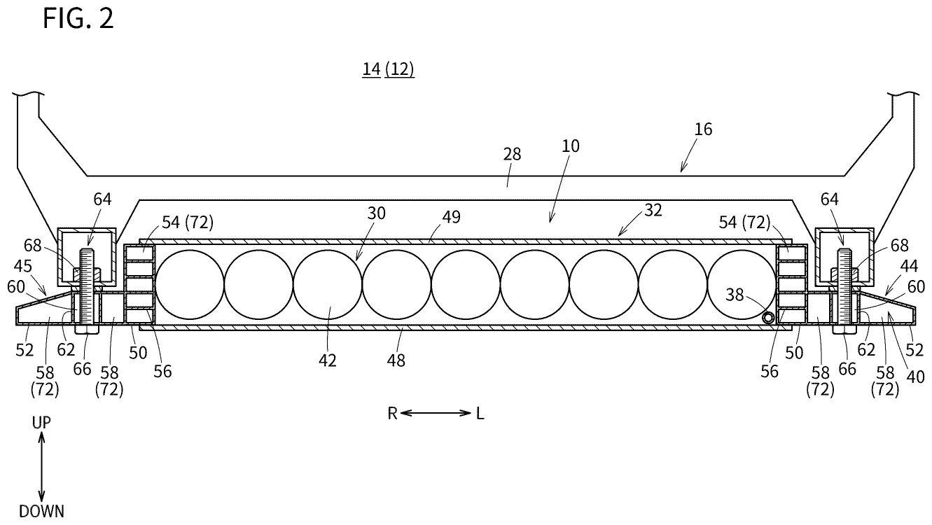

The vehicle 14 comprises a vehicle body 16, a pair of front wheels 18, a pair of front doors 20, a pair of rear doors 22, a pair of rear wheels 24, a motive power source 26, and the high pressure tank system 10. The vehicle body 16 includes a floor panel 28 (refer to FIG. 2).

The motive power source 26 is disposed in a front box (a motor room) that is disposed frontward (in the Fr direction) of the floor panel 28. The motive power source 26 is positioned between the pair of front wheels 18. The motive power source 26 is a motive power device (a power unit) that generates motive power such as electrical power or the like. The motive power source 26 includes a fuel cell that generates electricity by means of an electrochemical reaction between a fuel gas and an oxygen-containing gas. The motive power source 26 may include, for example, a hydrogen engine that is powered by a combustion reaction of the hydrogen gas. The motive power source 26 is positioned between a front end of the vehicle 14 and a group of high pressure tanks 30.

The high pressure tank system 10 includes the group of high pressure tanks 30, an accommodation unit 32, an opening/closing valve 34, a pressure reducing valve 36, a supply pipe 38, and a discharge flow path 40. The group of high pressure tanks 30 includes a plurality of high pressure tanks 42. Each of the high pressure tanks 42 is filled with the fuel gas that is supplied to the motive power source 26. Specifically, each of the high pressure tanks 42 can be filled with the fuel gas at a pressure, for example, on the order of 70 MPa. As the fuel gas that is filled into the high pressure tanks 42, there may be cited, for example, a hydrogen gas. The fuel gas is not necessarily limited to being a hydrogen gas.

The high pressure tanks 42 are each formed in a cylindrical shape. The high pressure tanks 42 are formed, for example, by winding a band-shaped fiber bundle impregnated with a resin around the outer surface of a non-illustrated cylindrically shaped liner. An axis line of each of the plurality of high pressure tanks 42 extends in a first direction (a frontward/rearward direction of the vehicle 14) that is directed along the horizontal direction. The plurality of high pressure tanks 42 are arranged in a second direction (a widthwise direction of the vehicle 14) which is perpendicular to the first direction and directed along the horizontal direction. The group of high pressure tanks 30 is disposed downwardly of the floor panel 28 (refer to FIG. 2).

FIG. 2 is a schematic cross-sectional view taken along line II-II of FIG. 1. As shown in FIG. 1 and FIG. 2, the accommodation unit 32 serves to accommodate the group of high pressure tanks 30. The accommodation unit 32 serves to protect the group of high pressure tanks 30 at the time of a collision of the vehicle 14. The accommodation unit 32 seals the group of high pressure tanks 30. Moreover, it should be noted that the accommodation unit 32 need not necessarily seal the group of high pressure tanks 30. More specifically, an accommodation space of the accommodation unit 32 may be placed in communication with the exterior of the accommodation unit 32. The accommodation unit 32 is mounted to the vehicle body 16.

The accommodation unit 32 includes a pair of side wall portions 44 and 45, a pair of end wall portions 46 and 47, a lower wall portion 48, and an upper wall portion 49. The pair of side wall portions 44 and 45 cover at least a portion of the group of high pressure tanks 30 from the second direction (the direction in which the plurality of high pressure tanks 42 are arranged alongside one another). Stated otherwise, the side wall portion 44 covers at least a portion of the group of high pressure tanks 30 from the left direction (the L direction). The side wall portion 45 covers at least a portion of the group of high pressure tanks 30 from the right direction (the R direction). Each of the side wall portions 44 and 45 extends along the axis direction of the high pressure tanks 42 (the frontward/rearward direction of the vehicle 14).

As shown in FIG. 2, the side wall portion 44 is formed to be hollow. In accordance with this feature, a collision energy at the time when the vehicle 14 collides can be suitably absorbed by the side wall portion 44. The side wall portion 44 includes a base portion 50, and a protruding portion 52.

The height of the base portion 50 along the upward/downward direction is greater than the outer diameter of each of the high pressure tanks 42. The base portion 50 has a plurality of first through holes 54 formed therein. Each of the first through holes 54 extends along the first direction (the frontward/rearward direction of the vehicle 14).

In the example shown in FIG. 2, five of the first through holes 54 are formed in the base portion 50. The plurality of first through holes 54 are arranged one above the other in the upward/downward direction. The first through holes 54 are rectangular-shaped holes. A first partition wall 56 is disposed between each pair of adjacent ones of the first through holes 54. The first partition wall 56 extends along the horizontal direction. By the plurality of first through holes 54 being formed in the base portion 50, the base portion 50 functions as a shock absorbing structure.

The protruding portion 52 projects out from the base portion 50 toward the opposite side to the group of high pressure tanks 30. The protruding portion 52 is connected to a lower end of the base portion 50. The protruding portion 52 has a plurality of second through holes 58 and one hollow portion 60. Each of the second through holes 58 and the hollow portion 60 extends along the first direction (the frontward/rearward direction of the vehicle 14).

In the example shown in FIG. 2, two of the second through holes 58 are formed in the protruding portion 52. The second through holes 58 are rectangular-shaped holes. The hollow portion 60 is positioned between the two second through holes 58. A second partition wall 62 is disposed between the hollow portion 60 and each of the second through holes 58. The second partition wall 62 extends along the upward/downward direction. By the plurality of second through holes 58 and the hollow portion 60 being formed in the protruding portion 52, the protruding portion 52 functions as a shock absorbing structure.

A plurality of mounting members 64 in order to mount the accommodation unit 32 to the vehicle body 16 are provided in the side wall portion 44. The plurality of mounting members 64 are disposed at intervals in the frontward/rearward direction of the vehicle 14 (refer to FIG. 1). Each of the mounting members 64 includes a bolt 66 and a nut 68. The bolts 66 penetrate in the upward/downward direction through the protruding portion 52. The bolts 66 pass through the hollow portion 60. The nuts 68 are fixed to the vehicle body 16. By the bolts 66 being screw-engaged with the nuts 68, the accommodation unit 32 is fixed to the vehicle body 16. The side wall portion 45 is configured in the same manner as the side wall portion 44. The side wall portion 45 is mounted to the vehicle body 16 by the plurality of mounting members 64.

As shown in FIG. 1, the end wall portion 46 covers at least a portion of the group of high pressure tanks 30 from the frontward (the Fr direction). The end wall portion 46 mutually connects, to each other, end parts (end parts in the Fr direction) of the pair of side wall portions 44 and 45. The end wall portion 46 supports one end part of each of the high pressure tanks 42. The end wall portion 47 covers at least a portion of the group of high pressure tanks 30 from the rear (the Rr direction). The end wall portion 47 mutually connects, to each other, the other end parts (end parts in the Rr direction) of the pair of side wall portions 44 and 45. The end wall portion 47 supports another end part of each of the high pressure tanks 42.

As shown in FIG. 2, the lower wall portion 48 covers at least a portion of the group of high pressure tanks 30 from the downward. The upper wall portion 49 covers at least a portion of the group of high pressure tanks 30 from the upward.

As shown in FIG. 1, the opening/closing valve 34 is mounted on the end wall portion 47. The opening/closing valve 34 is a main stop valve in order to stop the supply of the fuel gas from the group of high pressure tanks 30 to the supply pipe 38. The pressure reducing valve 36 serves to reduce the pressure of the fuel gas that is guided from the opening/closing valve 34 to a predetermined pressure. The supply pipe 38 supplies the fuel gas that is drawn out from the group of high pressure tanks 30 to the motive power source 26. The supply pipe 38 is formed, for example, in a circular pipe shape (refer to FIG. 2). The supply pipe 38 is disposed in a manner so as to pass through the accommodation space of the accommodation unit 32. The supply pipe 38 is disposed at a position adjacent to the base portion 50 of the side wall portion 44. The size, the shape, and the like of the supply pipe 38 can be set appropriately.

The discharged gas which is guided from the motive power source 26 flows through the discharge flow path 40. Moisture (water) is contained within the discharged gas. According to the present embodiment, the fuel cells of the motive power source 26 discharge a fuel off-gas and an oxygen-containing off-gas. The fuel off-gas contains generated water that is generated during the generation of electricity. The motive power source 26 includes a gas-liquid separator which separates the fuel off-gas into a gas and a liquid and stores the liquid water that has been separated from the fuel off-gas. The motive power source 26, by using the fuel off-gas, discharges the liquid water that is stored in the gas-liquid separator into the discharge flow path 40. In this case, in order to dilute the fuel gas concentration (a hydrogen gas concentration) that is discharged from the vehicle 14, the motive power source 26 mixes the oxygen-containing off-gas or an oxygen-containing gas with the fuel off-gas. Therefore, the discharged gas containing the fuel off-gas and the liquid water flow through the discharge flow path 40. In many situations, the discharged gas is higher in temperature than the fuel gas with which the high pressure tanks 42 is filled.

The discharge flow path 40 is disposed in a manner so that the heat of the discharged gas that flows through the discharge flow path 40 can be transferred to the group of high pressure tanks 30. The accommodation unit 32 is provided with the discharge flow path 40. The discharge flow path 40 extends rearward (in the Rr direction) from the motive power source 26. The discharge flow path 40 includes a first discharge flow path 70, and a second discharge flow path 72. The first discharge flow path 70 guides the discharged gas which is discharged from the motive power source 26 into the pair of side wall portions 44 and 45. The first discharge flow path 70 is formed by a discharge pipe 74.

The discharge pipe 74 extends in the rearward direction from the motive power source 26, branches off to the left and right (in the widthwise direction of the vehicle 14), and is connected to one end (an end in the Fr direction) of each of the pair of side wall portions 44 and 45. The second discharge flow path 72 is disposed in the interior of each of the pair of side wall portions 44 and 45. The second discharge flow path 72 is formed by the plurality of first through holes 54 and the plurality of second through holes 58 of each of the side wall portions 44 and 45.

An interior space (the first discharge flow path 70) of the discharge pipe 74 communicates with the plurality of first through holes 54 and the plurality of second through holes 58 of each of the side wall portions 44 and 45. The interior space of the discharge pipe 74 does not communicate with the hollow portions 60 of the side wall portions 44 and 45. In each of the side wall portions 44 and 45, there are provided, for example, a non-illustrated wall portion that blocks communication between the interior space of the discharge pipe 74 and the hollow portion 60. The discharge outlet port of the second discharge flow path 72 may be positioned, for example, between the pair of rear wheels 24. In this case, when the occupant gets in the vehicle or gets out of the vehicle through the rear doors 22, it is possible to prevent the water, which is contained within the discharged gas that is discharged from the discharge outlet port, from splashing on the occupant. Moreover, the position of the discharge outlet port can be set appropriately. The discharge outlet port may be positioned between the pair of front wheels 18. The discharge outlet port may be positioned at a position rearward of the front wheels 18 and frontward of the rear wheels 24 in the frontward/rearward direction (the lengthwise direction) of the vehicle 14. In this case, the discharge outlet port may be positioned (in an inner space) between the pair of rear wheels 24 or (in an inner space) between the pair of front wheels 18, in the vehicle widthwise direction.

Next, a description will be given concerning the operations of the vehicle 14. In the case that the vehicle 14 is being driven, the fuel gas that is filled in the high pressure tanks 42 is supplied via the supply pipe 38 to the fuel cells of the motive power source 26. Further, the oxygen-containing gas is supplied to the fuel cells of the motive power source 26. In the fuel cells, the hydrogen gas and the oxygen-containing gas are consumed by way of an electrochemical reaction. As a result, electrical power is generated. The motive power source 26 discharges the discharged gas containing the moisture (the liquid water) that has been generated during the generation of electrical power into the discharge flow path 40. The discharged gas flows through the first discharge flow path 70 and the second discharge flow path 72 and is discharged to the exterior of the vehicle 14.

In the case that the fuel gas that is filled in the high pressure tanks 42 is supplied to the motive power source 26, since the fuel gas inside the high pressure tanks 42 undergoes adiabatic expansion, the temperature of the fuel gas decreases. In particular, in the case that the motive power source 26 is operated over a long time period and at a high output, the temperature of the fuel gas is likely to decrease. Since such a decrease in the temperature of the fuel gas can adversely influence the durability of seals in auxiliary components or the like, this must be taken into consideration when designing is carried out.

The discharged gas which is comparatively high in temperature flows through the discharge flow path 40. When the discharged gas flows through the second discharge flow path 72, the heat of the discharged gas is transferred to the accommodation space of the accommodation unit 32. In accordance with this feature, it is possible to heat the group of high pressure tanks 30 that are accommodated in the accommodation unit 32.

Since the accommodation unit 32 includes the lower wall portion 48 that covers at least a portion of the group of high pressure tanks 30 from the below, the heat of the accommodation space can be prevented from escaping from downwardly of the accommodation unit 32. In accordance with this feature, it is possible to efficiently heat the group of high pressure tanks 30. Further, since the accommodation unit 32 includes the upper wall portion 49 that covers at least a portion of the group of high pressure tanks 30 from the above, the heat of the accommodation space can be prevented from escaping from upwardly of the accommodation unit 32. In accordance with this feature, it is possible to efficiently heat the group of high pressure tanks 30.

Further, since the supply pipe 38 (the supply flow path) is disposed in the accommodation space of the accommodation unit 32, the fuel gas that flows through the supply pipe 38 can be heated. Furthermore, since the supply pipe 38 is adjacent to the side wall portion 44 (the second discharge flow path 72), the fuel gas that flows through the supply pipe 38 can be efficiently heated. The flow direction of the discharged gas that flows through the second discharge flow path 72 is opposite to the flow direction of the fuel gas that flows through the supply pipe 38. In this case, since a counterflow heat exchange takes place between the second discharge flow path 72 and the supply pipe 38, the fuel gas that flows through the supply pipe 38 can be heated more efficiently.

Since the second discharge flow path 72 is disposed in the interior of each of the pair of side wall portions 44 and 45, the entire accommodation space of the accommodation unit 32 can be efficiently heated. In accordance with this feature, it is possible to reduce variation in temperature of the plurality of high pressure tanks 42.

According to the present embodiment, since the discharge flow path 40 is positioned in a manner so that the heat of the discharged gas that flows through the discharge flow path 40 can be transferred to the group of high pressure tanks 30, the high pressure tanks 42 can be heated by the discharged gas. This feature can prevent the low temperature fuel gas from being supplied to the motive power source 26.

### First Exemplary Modification

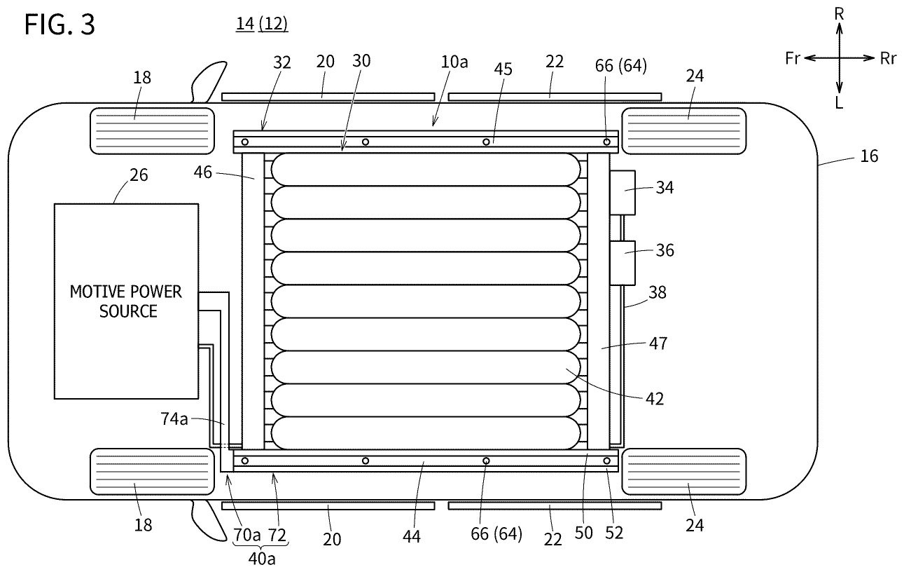

Next, a description will be given concerning a high pressure tank system 10a according to a first exemplary modification. FIG. 3 is a schematic diagram of the high pressure tank system 10a according to the first exemplary modification. Among the constituent components of the high pressure tank system 10a according to the first exemplary modification, the same constituent components as those of the above-described high pressure tank system 10 are designated by the same reference numerals, and detailed description of such features will be omitted.

As shown in FIG. 3, the high pressure tank system 10a includes a discharge flow path 40a, instead of the discharge flow path 40. A first discharge flow path 70a of the discharge flow path 40a guides the discharge gas that is discharged from the motive power source 26, only to the side wall portion 44. A discharge pipe 74a that forms the discharge flow path 40a is connected to only one end part (the end part in the Fr direction) of the side wall portion 44. More specifically, the discharged gas that flows through the first discharge flow path 70a is not guided to the side wall portion 45. For this purpose, the second discharge flow path 72 of the discharge flow path 40a is disposed only in the interior of the side wall portion 44. In such a configuration as well, the same advantageous effects as those of the above-described high pressure tank system 10 are realized.

The first discharge flow path 70a (the discharge pipe 74a) of the high pressure tank system 10a may be configured in a manner so as to guide the discharged gas only to the side wall portion 45, and not to guide the discharged gas to the side wall portion 44.

### Second Exemplary Modification

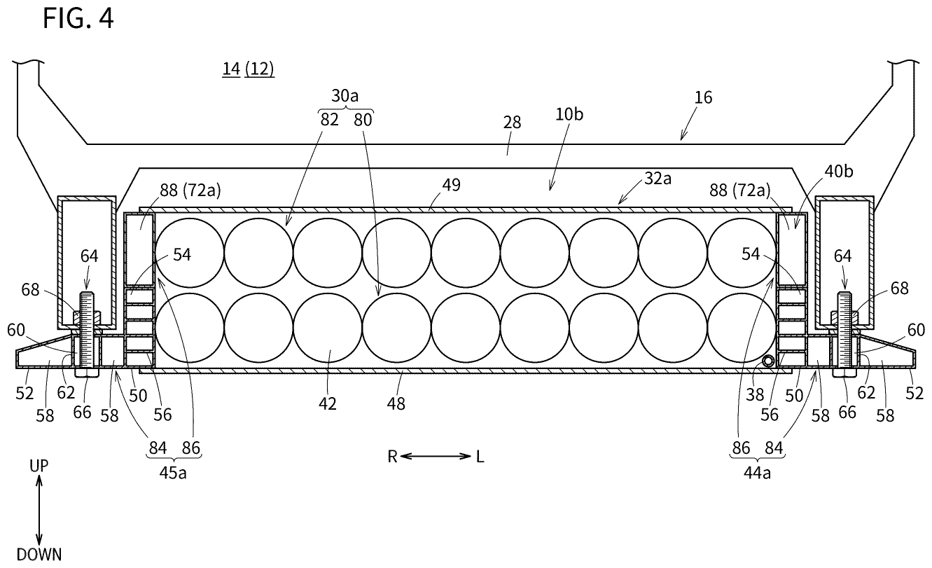

Next, a description will be given concerning a high pressure tank system 10b according to a second exemplary modification. FIG. 4 is a schematic cross-sectional view of the high pressure tank system 10b according to the second exemplary modification. Among the constituent components of the high pressure tank system 10b according to the second exemplary modification, the same constituent components as those of the above-described high pressure tank systems 10 and 10a are designated by the same reference numerals, and detailed description of such features will be omitted.

As shown in FIG. 4, the high pressure tank system 10b includes a group of high pressure tanks 30a, an accommodation unit 32a, the opening/closing valve 34 (refer to FIG. 1), the pressure reducing valve 36 (refer to FIG. 1), the supply pipe 38, and a discharge flow path 40b.

The group of high pressure tanks 30a includes a first group of high pressure tanks 80 and a second group of high pressure tanks 82. In each of the first group of high pressure tanks 80 and the second group of high pressure tanks 82, an axis line of each of the plurality of high pressure tanks 42 extends in the first direction (the frontward/rearward direction of the vehicle 14) along the horizontal direction. In each of the first group of high pressure tanks 80 and the second group of high pressure tanks 82, the plurality of high pressure tanks 42 are arranged in the second direction (the widthwise direction of the vehicle 14) which is perpendicular to the first direction and directed along the horizontal direction.

The accommodation unit 32a comprises side wall portions 44a and 45a in place of the aforementioned side wall portions 44 and 45. The side wall portion 44a includes a first portion 84 and a second portion 86. The first portion 84 covers the first group of high pressure tanks 80 from the second direction (the widthwise direction of the vehicle 14). The first portion 84 is configured in the same manner as the aforementioned side wall portion 44.

The second portion 86 covers the second group of high pressure tanks 82 from the second direction (the widthwise direction of the vehicle 14). The second portion 86 is disposed upwardly of the first portion 84 so as to be adjacent to each other. More specifically, the second portion 86 is fixed to an upper part of the first portion 84. A heigh of the second portion 86 along the upward/downward direction is greater than the outer diameter of each of the high pressure tanks 42. The second portion 86 is formed to be hollow. The second portion 86 has a third through hole 88 formed therein. The third through hole 88 extends in the first direction (the frontward/rearward direction of the vehicle 14). The second portion 86 is formed in a rectangular pipe shape. The side wall portion 45a is configured in the same manner as the side wall portion 44a.

The discharge flow path 40b includes the first discharge flow path 70 (refer to FIG. 1), and a second discharge flow path 72a. The second discharge flow path 72a is formed by the third through hole 88 of each of the side wall portions 44a and 45a. The interior space of the discharge pipe 74 communicates with the third through hole 88 of each of the side wall portions 44a and 45a. The interior space of the discharge pipe 74 does not communicate with the first through holes 54 and the second through holes 58 of each of the side wall portions 44a and 45a.

In accordance with such a configuration, the accommodation space of the accommodation unit 32a can be heated by the heat of the discharged gas that flows through the third through hole 88 (the second discharge flow path 72a) of each of the side wall portions 44a and 45a. In accordance with this feature, it is possible to heat the group of high pressure tanks 30a. Further, since the first portion 84 projects out with respect to the second portion 86 toward the opposite side to the group of high pressure tanks 30a, it is possible to prevent the high pressure tank system 10b from becoming large in scale in the second direction.

### Third Exemplary Modification

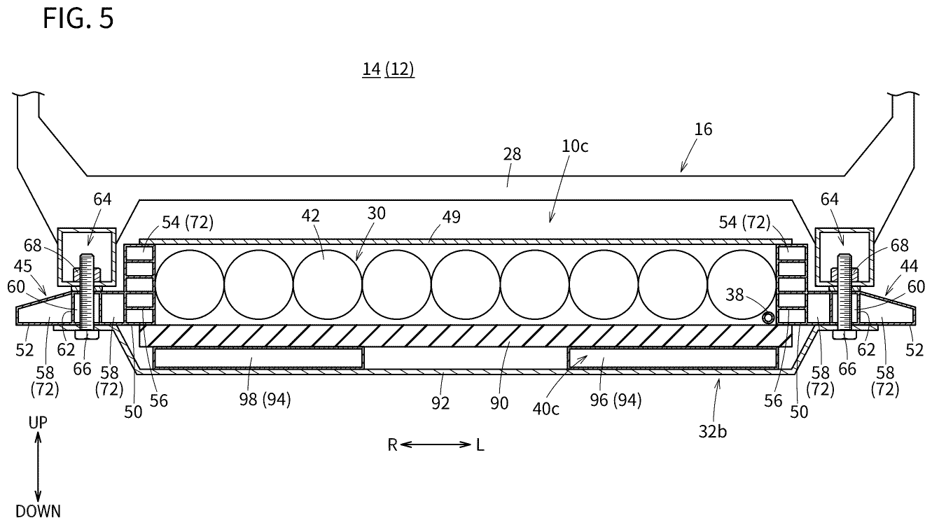

Next, a description will be given concerning a high pressure tank system 10c according to a third exemplary modification. FIG. 5 is a schematic cross-sectional view of the high pressure tank system 10c according to the third exemplary modification. Among the constituent components of the high pressure tank system 10c according to the third exemplary modification, the same constituent components as those of the above-described high pressure tank systems 10, 10a, and 10b are designated by the same reference numerals, and detailed description of such features will be omitted.

As shown in FIG. 5, the high pressure tank system 10c includes the group of high pressure tanks 30, an accommodation unit 32b, the opening/closing valve 34 (refer to FIG. 1), the pressure reducing valve 36 (refer to FIG. 1), the supply pipe 38, a discharge flow path 40c, and a lower-side heat insulating member 90.

The accommodation unit 32b includes the pair of side wall portions 44 and 45, the pair of end wall portions 46 and 47 (refer to FIG. 1), a lower cover member 92, and the upper wall portion 49. The lower cover member 92 constitutes at least a portion of an under panel of the vehicle 14. The lower cover member 92 covers from the below at least a portion of the group of high pressure tanks 30. The lower cover member 92 is fixed to the pair of side wall portions 44 and 45 by using the mounting members 64.

The discharge flow path 40c is disposed in a manner so that the heat of the discharged gas that flows through the discharge flow path 40c can be transferred to the group of high pressure tanks 30. The accommodation unit 32b is provided with the discharge flow path 40c. The discharge flow path 40c includes a lower-side discharge flow path 94. The lower-side discharge flow path 94 is positioned downwardly of the group of high pressure tanks 30. Stated otherwise, the lower-side discharge flow path 94 is disposed between the group of high pressure tanks 30 and the lower cover member 92. The lower-side discharge flow path 94 is connected to the motive power source 26.

The lower-side discharge flow path 94 includes a first lower-side discharge flow path 96, and a second lower-side discharge flow path 98. Each of the first lower-side discharge flow path 96 and the second lower-side discharge flow path 98 is formed by piping. The first lower-side discharge flow path 96 and the second lower-side discharge flow path 98 are aligned alongside one another in the second direction (the widthwise direction of the vehicle 14). A gap (a space) is formed between the first lower-side discharge flow path 96 and the second lower-side discharge flow path 98. The first lower-side discharge flow path 96 is positioned downwardly of one end part of the group of high pressure tanks 30 in the second direction (i.e., an end part in the L direction). The second lower-side discharge flow path 98 is positioned downwardly of another end part of the group of high pressure tanks 30 in the second direction (i.e., an end part in the R direction).

The cross section of the first lower-side discharge flow path 96 is of a flattened rectangular shape. The height of the first lower-side discharge flow path 96 along the upward/downward direction is smaller than the width of the first lower-side discharge flow path 96 along the second direction. The cross section of the second lower-side discharge flow path 98 is of a flattened rectangular shape. The height of the second lower-side discharge flow path 98 along the upward/downward direction is smaller than the width of the second lower-side discharge flow path 98 along the second direction.

The piping that constitutes the first lower-side discharge flow path 96 is in contact with or in close proximity to the lower cover member 92. The piping that constitutes the second lower-side discharge flow path 98 is in contact with or in close proximity to the lower cover member 92. The piping that constitutes the first lower-side discharge flow path 96 and the piping that constitutes the second lower-side discharge flow path 98 may be connected to the lower cover member 92. In this case, the rigidity of the lower cover member 92 can be enhanced.

The lower-side heat insulating member 90 is disposed between the lower-side discharge flow path 94 and the group of high pressure tanks 30. The lower-side heat insulating member 90 covers from the below at least a portion of the group of high pressure tanks 30. The lower-side heat insulating member 90 suppresses heat transfer from the lower-side discharge flow path 94 to the group of high pressure tanks 30. The lower-side heat insulating member 90 is constituted, for example, by glass wool, expanded polystyrene, a heat shield plate, or the like. The heat shield plate may be, for example, an iron plate.

According to the present exemplary modification, the discharge flow path 40c includes the lower-side discharge flow path 94 that is disposed downwardly of the group of high pressure tanks 30. The lower-side heat insulating member 90 is disposed between the group of high pressure tanks 30 and the lower-side discharge flow path 94. In accordance with such a configuration, the group of high pressure tanks 30 can be heated by the heat of the discharged gas that flows through the lower-side discharge flow path 94. Further, the lower-side heat insulating member 90 is capable of preventing the high pressure tanks 42 that are positioned in close proximity to the lower-side discharge flow path 94 from being excessively heated by the heat of the discharged gas that flows through the lower-side discharge flow path 94. Furthermore, the group of high pressure tanks 30 can be protected by the lower-side discharge flow path 94 and the lower-side heat insulating member 90.

The height of the lower-side discharge flow path 94 along the upward/downward direction is smaller than the width of the lower-side discharge flow path 94 along the second direction. In accordance with such a configuration, the high pressure tank system 10c can be made smaller in scale in the upward/downward direction.

The accommodation unit 32b includes the lower cover member 92 that is disposed downwardly of the lower-side discharge flow path 94. In accordance with such a configuration, the lower cover member 92 can prevent the heat of the discharged gas that flows through the lower-side discharge flow path 94 from escaping from the lower side of the accommodation unit 32b. Further, the group of high pressure tanks 30 can be protected by the lower cover member 92.

The accommodation unit 32b includes the side wall portions 44 and 45 that serve to cover the group of high pressure tanks 30 from the second direction. The lower cover member 92 is mounted to the side wall portions 44 and 45. The mounting members 64 in order to mount the accommodation unit 32b to the vehicle body 16 are provided in the side wall portions 44 and 45. In accordance with such a configuration, the rigidity of the accommodation unit 32b can be increased.

In the high pressure tank system 10c, in the lower-side discharge flow path 94, there may be omitted either one of the first lower-side discharge flow path 96 and the second lower-side discharge flow path 98. Further, the lower-side discharge flow path 94 may be formed by disposing three or more of the pipings downwardly of the group of high pressure tanks 30.

### Fourth Exemplary Modification

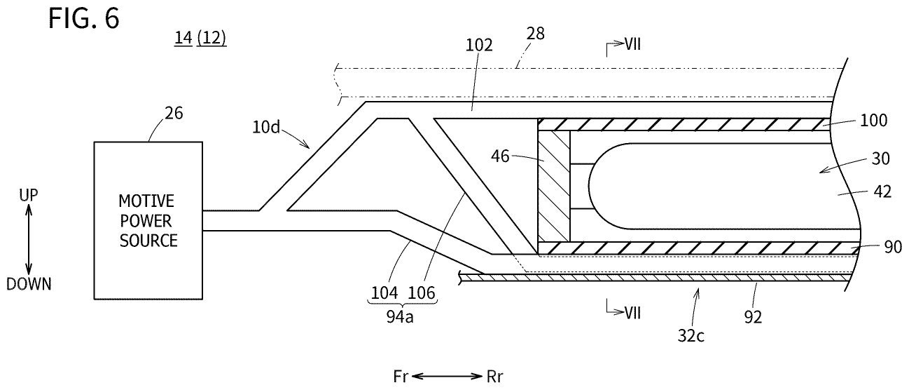

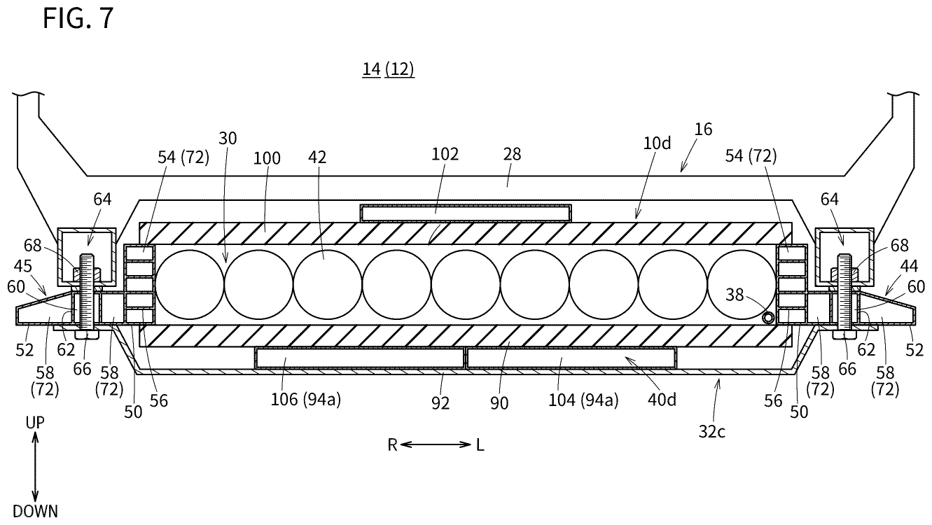

Next, a description will be given concerning a high pressure tank system 10d according to a fourth exemplary modification. FIG. 6 is a schematic diagram of the high pressure tank system 10d according to the fourth exemplary modification. FIG. 7 is a schematic cross-sectional view taken along line VII-VII of FIG. 6. Among the constituent components of the high pressure tank system 10d according to the fourth exemplary modification, the same constituent components as those of the above-described high pressure tank systems 10 and 10a to 10c are designated by the same reference numerals, and detailed description of such features will be omitted.

As shown in FIG. 6 and FIG. 7, the high pressure tank system 10d includes the group of high pressure tanks 30, an accommodation unit 32c, the opening/closing valve 34 (refer to FIG. 1), the pressure reducing valve 36 (refer to FIG. 1), the supply pipe 38, a discharge flow path 40d, the lower-side heat insulating member 90, and an upper-side heat insulating member 100.

The accommodation unit 32c includes the pair of side wall portions 44 and 45, the pair of end wall portions 46 and 47 (refer to FIG. 1), and the lower cover member 92. The accommodation unit 32c does not include the aforementioned lower and upper wall portions 48 and 49.

The discharge flow path 40d is disposed in a manner so that the heat of the discharged gas that flows through the discharge flow path 40d can be transferred to the group of high pressure tanks 30. The accommodation unit 32c is provided with the discharge flow path 40d. The discharge flow path 40d includes a lower-side discharge flow path 94a and an upper-side discharge flow path 102. The lower-side discharge flow path 94a includes a first lower-side discharge flow path 104 and a second lower-side discharge flow path 106. Each of the first lower-side discharge flow path 104, the second lower-side discharge flow path 106, and the upper-side discharge flow path 102 is formed by piping.

As shown in FIG. 6, the first lower-side discharge flow path 104 is connected to the motive power source 26. The discharged gas (the fuel off-gas) that is discharged from the motive power source 26 and the liquid water that is stored in a gas-liquid separator of the motive power source 26 flow through the first lower-side discharge flow path 104.

The upper-side discharge flow path 102 is connected to a portion, of the first lower-side discharge flow path 104, that is more frontward (in the Fr direction) than the group of high pressure tanks 30. The upper-side discharge flow path 102 extends obliquely upward along the rearward direction (the Rr direction) from the first lower-side discharge flow path 104. The discharged gas (the fuel off-gas) flows through the upper-side discharge flow path 102. The liquid water that is discharged from the motive power source 26 flows in the direction of gravity, and therefore, does not easily flow into the upper-side discharge flow path 102.

The second lower-side discharge flow path 106 is connected to a portion, of the upper-side discharge flow path 102, that is more frontward (in the Fr direction) than the group of high pressure tanks 30. The second lower-side discharge flow path 106 extends obliquely downward along the rearward direction (the Rr direction) from the upper-side discharge flow path 102. The discharged gas (the fuel off-gas) flows through the second lower-side discharge flow path 106. Since the second lower-side discharge flow path 106 is connected to the upper-side discharge flow path 102, the liquid water that is discharged from the motive power source 26 is unlikely to flow through the second lower-side discharge flow path 106. Therefore, the proportion of the liquid water contained in the discharged gas that flows through the second lower-side discharge flow path 106 is smaller than the proportion of the liquid water contained in the discharged gas that flows through the first lower-side discharge flow path 104.

As shown in FIG. 7, the first lower-side discharge flow path 104 and the second lower-side discharge flow path 106 are mutually adjacent to each other in the second direction. Stated otherwise, the piping that forms the first lower-side discharge flow path 104 and the piping that forms the second lower-side discharge flow path 106 are in contact with or in close proximity to each other. The first lower-side discharge flow path 104 and the second lower-side discharge flow path 106 are positioned downwardly of the group of high pressure tanks 30. Stated otherwise, the first lower-side discharge flow path 104 and the second lower-side discharge flow path 106 are positioned between the group of high pressure tanks 30 and the lower cover member 92.

The cross section of the first lower-side discharge flow path 104 is of a flattened rectangular shape. The height of the first lower-side discharge flow path 104 along the upward/downward direction is smaller than the width of the first lower-side discharge flow path 104 along the second direction. The cross section of the second lower-side discharge flow path 106 is of a flattened rectangular shape. The height of the second lower-side discharge flow path 106 along the upward/downward direction is smaller than the width of the second lower-side discharge flow path 106 along the second direction.

The piping that constitutes the first lower-side discharge flow path 104 is in contact with or in close proximity to the lower cover member 92. The piping that constitutes the second lower-side discharge flow path 106 is in contact with or in close proximity to the lower cover member 92. The piping that constitutes the first lower-side discharge flow path 104 and the piping that constitutes the second lower-side discharge flow path 106 may be connected to the lower cover member 92. In this case, the rigidity of the lower cover member 92 can be increased.

The upper-side discharge flow path 102 is positioned upwardly of the group of high pressure tanks 30. Stated otherwise, the upper-side discharge flow path 102 is disposed between the group of high pressure tanks 30 and the floor panel 28. The upper-side discharge flow path 102 is positioned upwardly of a central part in the second direction of the group of high pressure tanks 30. The cross section of the upper-side discharge flow path 102 is of a flattened rectangular shape. The height of the upper-side discharge flow path 102 along the upward/downward direction is smaller than the width of the upper-side discharge flow path 102 along the second direction.

The lower-side heat insulating member 90 is disposed between the lower-side discharge flow path 94a and the group of high pressure tanks 30. The lower-side heat insulating member 90 covers from the below at least a portion of the group of high pressure tanks 30. The lower-side heat insulating member 90 inhibits transfer of heat from the lower-side discharge flow path 94a to the group of high pressure tanks 30. This feature can prevent the high pressure tanks 42 that are positioned in close proximity to the lower-side discharge flow path 94a from becoming excessively heated by the heat of the discharged gas that flows through the lower-side discharge flow path 94a.

The upper-side heat insulating member 100 is positioned between the upper-side discharge flow path 102 and the group of high pressure tanks 30. The upper-side heat insulating member 100 covers from the above at least a portion of the group of high pressure tanks 30. The upper-side heat insulating member 100 inhibits transfer of heat from the upper-side discharge flow path 102 to the group of high pressure tanks 30. This feature can prevent the high pressure tanks 42, which are positioned in close proximity to the upper-side discharge flow path 102, from being excessively heated by the discharged gas that flows through the upper-side discharge flow path 102. The upper-side heat insulating member 100 can be constituted by the same material as the lower-side heat insulating member 90.

According to the present exemplary modification, the same advantageous effects as those of the above-described high pressure tank system 10c according to the third exemplary modification are realized.

According to the present exemplary modification, the lower-side discharge flow path 94a includes the first lower-side discharge flow path 104 and the second lower-side discharge flow path 106 which are disposed adjacently to each other in the second direction. The discharged gas and the liquid water flow through the first lower-side discharge flow path 104. The discharged gas flows through the second lower-side discharge flow path 106.

In accordance with such a configuration, even in the case that the liquid water flowing through the first lower-side discharge flow path 104 becomes frozen, the ice in the first lower-side discharge flow path 104 can be melted by the heat of the discharged gas that flows through the second lower-side discharge flow path 106. In accordance with this feature, when the motive power source 26 is operated in a sub-freezing environment, it is possible to prevent the discharge flow path 40d from becoming completely blocked.

The discharge flow path 40d includes the upper-side discharge flow path 102 that is disposed upwardly of the group of high pressure tanks 30. The upper-side heat insulating member 100 is disposed between the group of high pressure tanks 30 and the upper-side discharge flow path 102.

In accordance with such a configuration, the group of high pressure tanks 30 can be heated by the heat of the discharged gas that flows through the upper-side discharge flow path 102. Further, the high pressure tanks 42, which are comparatively close in proximity to the upper-side discharge flow path 102, can be prevented from being excessively heated by the discharged gas that flows through the upper-side discharge flow path 102. Furthermore, the group of high pressure tanks 30 can be protected by the upper-side discharge flow path 102 and the upper-side heat insulating member 100.

The height of the upper-side discharge flow path 102 along the upward/downward direction is smaller than the width of the upper-side discharge flow path 102 along the second direction. In accordance with such a configuration, the high pressure tank system 10d can be made smaller in scale in the upward/downward direction.

### Fifth Exemplary Modification

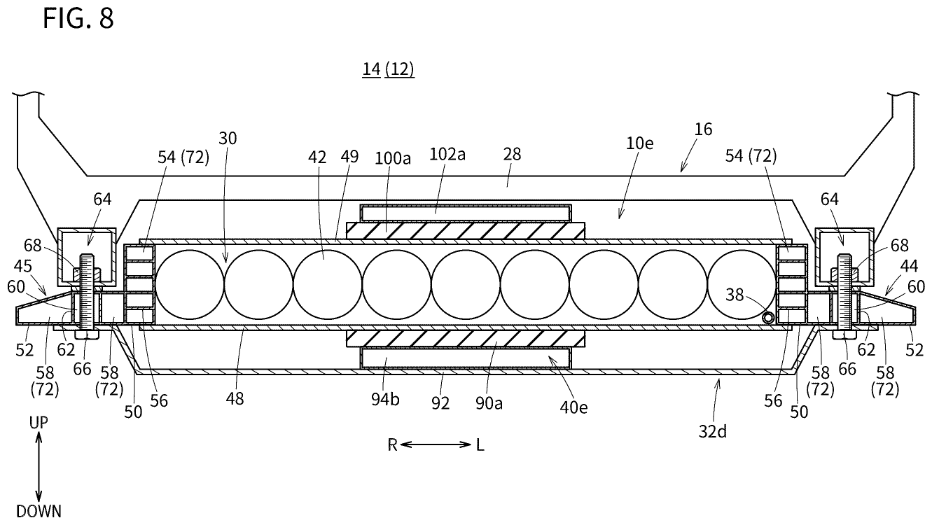

Next, a description will be given concerning a high pressure tank system 10e according to a fifth exemplary modification. FIG. 8 is a schematic cross-sectional view of the high pressure tank system 10e according to the fifth exemplary modification. Among the constituent components of the high pressure tank system 10e according to the fifth exemplary modification, the same constituent components as those of the above-described high pressure tank systems 10 and 10a to 10d are designated by the same reference numerals, and detailed description of such features will be omitted.

As shown in FIG. 8, the high pressure tank system 10e includes the group of high pressure tanks 30, an accommodation unit 32d, the opening/closing valve 34 (refer to FIG. 1), the pressure reducing valve 36 (refer to FIG. 1), the supply pipe 38, a discharge flow path 40e, a lower-side heat insulating member 90a, and an upper-side heat insulating member 100a.

The accommodation unit 32d includes the pair of side wall portions 44 and 45, the pair of end wall portions 46 and 47 (refer to FIG. 1), the lower wall portion 48, the lower cover member 92, and the upper wall portion 49. The discharge flow path 40e is disposed in a manner so that the heat of the discharged gas that flows through the discharge flow path 40e can be transferred to the group of high pressure tanks 30. The accommodation unit 32d is provided with the discharge flow path 40e.

The discharge flow path 40e includes a lower-side discharge flow path 94b and an upper-side discharge flow path 102a. Each of the lower-side discharge flow path 94b and the upper-side discharge flow path 102a is formed by piping. The lower-side discharge flow path 94b is positioned downwardly of a central part in the second direction of the group of high pressure tanks 30. The cross section of the lower-side discharge flow path 94b is of a flattened rectangular shape. The height of the lower-side discharge flow path 94b along the upward/downward direction is smaller than the width of the lower-side discharge flow path 94b along the second direction.

The piping that constitutes the lower-side discharge flow path 94b is in contact with or in close proximity to the lower cover member 92. The piping that constitutes the lower-side discharge flow path 94b may be connected to the lower cover member 92. In this case, the rigidity of the lower cover member 92 can be increased.

The lower-side heat insulating member 90a is positioned between the lower wall portion 48 and the lower-side discharge flow path 94b. The lower-side heat insulating member 90a is mounted on the external surface of the lower wall portion 48. The lower-side heat insulating member 90a is disposed at a central part in the second direction of the lower wall portion 48. The lower-side heat insulating member 90a is not disposed at both ends in the second direction of the lower wall portion 48. The lower-side heat insulating member 90a is constituted by the same material as the lower-side heat insulating member 90.

The upper-side heat insulating member 100a is positioned between the upper wall portion 49 and the upper-side discharge flow path 102a. The upper-side heat insulating member 100a is mounted on the external surface of the upper wall portion 49. The upper-side heat insulating member 100a is disposed at a central part in the second direction of the upper wall portion 49. The upper-side heat insulating member 100a is not disposed at both ends in the second direction of the upper wall portion 49. The upper-side heat insulating member 100a is constituted by the same material as the lower-side heat insulating member 90.

In the high pressure tank system 10e according to the present exemplary modification, the same advantageous effects as those of the above-described high pressure tank systems 10c and 10d are realized.

In the high pressure tank system 10e, either one of the upper-side discharge flow path 102a and the lower-side discharge flow path 94b may be omitted.

In the above-described high pressure tank systems 10 and 10a to 10e, the discharge flow paths 40 and 40a to 40e are disposed in a manner so that the heat of the discharged gas that flows through the discharge flow paths 40 and 40a to 40e can be transferred to the group of high pressure tanks 30 and 30a. Therefore, the high pressure tanks 42 can be heated by the discharged gas. In accordance with this feature, it is possible to prevent the low temperature fuel gas from being supplied to the motive power source 26.

In relation to the above-described embodiments, the following Supplementary Notes are further disclosed.

### (Supplementary Note 1)

The high pressure tank system (10, 10a to 10e) of the present disclosure includes the group of high pressure tanks (30, 30a) including the plurality of cylindrically shaped high pressure tanks (42) which are filled with the fuel gas that is supplied to the motive power source (26), the accommodation unit (32, 32a to 32d) configured to accommodate the group of high pressure tanks, and the discharge flow path (40, 40a to 40e) through which the discharged gas that is guided from the motive power source flows, wherein the accommodation unit is provided with the discharge flow path, and the discharge flow path is disposed in a manner so that heat of the discharged gas flowing through the discharge flow path is capable of being transferred to the group of high pressure tanks.

In accordance with such a configuration, since the accommodation unit is provided with the discharge flow path and the discharge flow path is disposed in a manner so that heat of the discharged gas flowing through the discharge flow path is transferable to the group of high pressure tanks, the high pressure tanks that are disposed in the accommodation space of the accommodation unit can be heated by the heat of the discharged gas. This feature can prevent the low temperature fuel gas from being supplied to the motive power source.

### (Supplementary Note 2)

In the high pressure tank system according to Supplementary Note 1, the axis line of each of the plurality of high pressure tanks may extend in the first direction that is directed along the horizontal direction, the plurality of high pressure tanks are arranged in the second direction that is perpendicular to the first direction and directed along the horizontal direction, the accommodation unit may include the side wall portion (44, 44a, 45, 45a) that covers the group of high pressure tanks from the second direction, and the side wall portion may include the discharge flow path.

In accordance with such a configuration, it is possible to efficiently heat the group of high pressure tanks by using the heat of the discharged gas that flows through the discharge flow path.

### (Supplementary Note 3)

In the high pressure tank system according to Supplementary Note 2, the side wall portion and the discharge flow path may extend along the first direction.

In accordance with such a configuration, since the discharged gas can be caused to flow along the axis direction of the high pressure tanks, it is possible to heat the group of high pressure tanks more efficiently.

### (Supplementary Note 4)

In the high pressure tank system according to Supplementary Note 3, the discharge flow path may be disposed in the interior of the side wall portion.

In accordance with such a configuration, the high pressure tank system can be miniaturized.

### (Supplementary Note 5)

In the high pressure tank system according to Supplementary Note 4, the through hole (54, 58, 88) that extends along the first direction may be formed in the side wall portion, and at least a portion of the discharge flow path may be formed by the through hole.

In accordance with such a configuration, since there is no need to pass a piping through the interior of the side wall portion, the side wall portion can have a simple configuration.

### (Supplementary Note 6)

In the high pressure tank system according to any one of Supplementary Notes 2 to 5, the side wall portion may be provided with the mounting member (64) that serves to mount the accommodation unit on the vehicle body (16).

In accordance with such a configuration, the rigidity of the side wall portion can be increased. Therefore, the group of high pressure tanks can be protected more safely by the accommodation unit.

### (Supplementary Note 7)

The high pressure tank system of the present disclosure includes the group of high pressure tanks including the plurality of cylindrically shaped high pressure tanks which are filled with the fuel gas that is supplied to the motive power source, the accommodation unit configured to accommodate the group of high pressure tanks, and the discharge flow path through which the discharged gas that is guided from the motive power source flows, wherein the discharge flow path is disposed in a manner so that the heat of the discharged gas flowing through the discharge flow path is capable of being transferred to the group of high pressure tanks, the axis line of each of the plurality of high pressure tanks extends in the first direction that is directed along the horizontal direction, the plurality of high pressure tanks are arranged in the second direction that is perpendicular to the first direction and directed along the horizontal direction, the accommodation unit includes the side wall portion that covers the group of high pressure tanks from the second direction, the side wall portion is provided with the discharge flow path, the group of high pressure tanks includes the first group of high pressure tanks (80) and the second group of high pressure tanks (82) that are disposed mutually adjacent to each other in the upward/downward direction, the side wall portion includes the first portion (84) that covers the first group of high pressure tanks from the second direction, and the second portion (86) adjacent to the first portion in the upward/downward direction, and that covers the second group of high pressure tanks from the second direction, the second portion includes the discharge flow path, and the first portion projects out with respect to the second portion toward the opposite side to the group of high pressure tanks.

In accordance with such a configuration, the accommodation space of the accommodation unit can be heated by the heat of the discharged gas that flows through the discharge flow path provided in the second portion. In accordance with this feature, it is possible to heat the group of high pressure tanks. Further, since the first portion projects out with respect to the second portion toward the opposite side to the group of high pressure tanks, it is possible to provide the discharge flow path in the accommodation unit while keeping the high pressure tank system compact. Thus, it is possible to prevent the high pressure tank system from becoming large in scale in the second direction.

### (Supplementary Note 8)

The high pressure tank system of the present disclosure includes the group of high pressure tanks including the plurality of cylindrically shaped high pressure tanks which are filled with the fuel gas that is supplied to the motive power source, the accommodation unit configured to accommodate the group of high pressure tanks, and the discharge flow path through which the discharged gas that is guided from the motive power source flows, wherein the discharge flow path is disposed in a manner so that the heat of the discharged gas flowing through the discharge flow path is capable of being transferred to the group of high pressure tanks, the axis line of each of the plurality of high pressure tanks extends in the first direction that is directed along the horizontal direction, the plurality of high pressure tanks are arranged in the second direction that is perpendicular to the first direction and directed along the horizontal direction, the discharge flow path includes the lower-side discharge flow path (94, 94a, 94b) disposed downwardly of the group of high pressure tanks, and the lower-side heat insulating member (90, 90a) is disposed between the group of high pressure tanks and the lower-side discharge flow path.

In accordance with such a configuration, it is possible to heat the group of high pressure tanks by using the heat of the discharged gas that flows through the lower-side discharge flow path. Further, the lower-side heat insulating member is capable of preventing the high pressure tanks that are positioned in close proximity to the lower-side discharge flow path from being excessively heated by the heat of the discharged gas that flows through the lower-side discharge flow path. Furthermore, the group of high pressure tanks can be protected by the lower-side discharge flow path and the lower-side heat insulating member.

### (Supplementary Note 9)

In the high pressure tank system according to Supplementary Note 8, the height of the lower-side discharge flow path along the upward/downward direction may be smaller than the width of the lower-side discharge flow path along the second direction.

In accordance with such a configuration, the high pressure tank system can be made smaller in scale in the upward/downward direction.

### (Supplementary Note 10)

In the high pressure tank system according to Supplementary Note 8 or 9, the accommodation unit may include the lower cover member (92) that is disposed downwardly of the lower-side discharge flow path.

In accordance with such a configuration, the lower cover member can prevent the heat of the discharged gas that flows through the lower-side discharge flow path from escaping from the lower side of the accommodation unit. Further, the group of high pressure tanks can be protected by the lower cover member.

### (Supplementary Note 11)

In the high pressure tank system according to Supplementary Note 10, the accommodation unit may include the side wall portion that covers the group of high pressure tanks from the second direction, the lower cover member may be mounted to the side wall portion, and the side wall portion may be provided with the mounting member that serves to mount the accommodation unit on the vehicle body.

In accordance with such a configuration, the rigidity of the accommodation unit can be increased.

### (Supplementary Note 12)

In the high pressure tank system according to any one of Supplementary Notes 8 to 11, the lower-side discharge flow path may include the first lower-side discharge flow path (104) and the second lower-side discharge flow path (106) which are disposed mutually adjacent to each other in the second direction, and the proportion of the liquid water contained in the discharged gas flowing through the second lower-side discharge flow path may be smaller than the proportion of the liquid water contained in the discharged gas flowing through the first lower-side discharge flow path.

In accordance with such a configuration, even in the case that the liquid water flowing through the first lower-side discharge flow path becomes frozen, the ice in the first lower-side discharge flow path can be melted by the heat of the discharged gas that flows through the second lower-side discharge flow path. In accordance with this feature, when the motive power source is operated in a sub-freezing environment, it is possible to prevent the discharge flow path from becoming completely blocked.

### (Supplementary Note 13)

The high pressure tank system of the present disclosure includes the group of high pressure tanks including the plurality of cylindrically shaped high pressure tanks which are filled with the fuel gas that is supplied to the motive power source, the accommodation unit configured to accommodate the group of high pressure tanks, and the discharge flow path through which the discharged gas that is guided from the motive power source flows, wherein the discharge flow path is disposed in a manner so that heat of the discharged gas flowing through the discharge flow path can be transferred to the group of high pressure tanks, the axis line of each of the plurality of high pressure tanks extends in the first direction that is directed along the horizontal direction, the plurality of high pressure tanks are arranged in the second direction that is perpendicular to the first direction and directed along the horizontal direction, the discharge flow path includes the upper-side discharge flow path (102, 102a) disposed upwardly of the group of high pressure tanks, and the upper-side heat insulating member (100, 100a) is disposed between the group of high pressure tanks and the upper-side discharge flow path.

In accordance with such a configuration, it is possible to heat the group of high pressure tanks by the heat of the discharged gas that flows through the upper-side discharge flow path. Further, the high pressure tank, which is positioned comparatively close to the upper-side discharge flow path, can be prevented from being excessively heated by the discharged gas that flows through the upper-side discharge flow path. Furthermore, the group of high pressure tanks can be protected by the upper-side discharge flow path and the upper-side heat insulating member.

### (Supplementary Note 14)

In the high pressure tank system according to Supplementary Note 13, the height of the upper-side discharge flow path along the upward/downward direction may be smaller than the width of the upper-side discharge flow path along the second direction.

In accordance with such a configuration, the high pressure tank system can be made smaller in scale in the upward/downward direction.

### (Supplementary Note 15)

In the high pressure tank system according to Supplementary Note 14, the accommodation unit may include the lower cover member that is disposed downwardly of the group of high pressure tanks.

In accordance with such a configuration, the lower cover member can prevent the heat in the accommodation space of the accommodation unit from escaping from downwardly of the accommodation unit. Further, the group of high pressure tanks can be protected by the lower cover member.

### (Supplementary Note 16)

In the high pressure tank system according to Supplementary Note 15, the accommodation unit may include the side wall portion that covers the group of high pressure tanks from the second direction, the lower cover member may be mounted to the side wall portion, and the side wall portion may be provided with the mounting member that serves to mount the accommodation unit on the vehicle body.

In accordance with such a configuration, the rigidity of the accommodation unit can be increased.

### (Supplementary Note 17)

In the high pressure tank system according to any one of Supplementary Notes 1 to 16, the motive power source may include a fuel cell or a hydrogen engine, and the fuel gas may be a hydrogen gas.

In accordance with such a configuration, the hydrogen gas that is supplied to the motive power source can be heated by the discharged gas.

### (Supplementary Note 18)

The moving body (12) of the present disclosure includes the high pressure tank system according to any one of Supplementary Notes 1 to 17, and the motive power source.

In accordance with such a configuration, the moving body having the advantageous effects according to Supplementary Notes 1 to 17 can be obtained.

Although the present disclosure has been described in detail, the present disclosure is not necessarily limited to each of the aforementioned embodiments. These embodiments can be subjected to various additions, substitutions, modifications, partial deletions and the like, within a range that does not depart from the essence and gist of the present disclosure, or alternatively, the spirit and gist of the present disclosure as derived from the contents described in the claims and their equivalents. Further, the embodiments can also be implemented together in combination. For example, in the above-described embodiments, the order of each of the operations and the order of each of the processes are illustrated as examples, and the present disclosure is not necessarily limited to these features. The same applies also in the case that numerical values or mathematical equations are used in the description of the aforementioned embodiments.

1. A high pressure tank system, comprising:
a group of high pressure tanks comprising a plurality of high pressure tanks each having a cylindrical shape, the high pressure tanks being configured to be filled with a fuel gas that is supplied to a motive power source;
an accommodation unit configured to accommodate the group of high pressure tanks; and
a discharge flow path through which a discharged gas that is guided from the motive power source flows,
wherein the accommodation unit is provided with the discharge flow path, and the discharge flow path is disposed in a manner so that heat of the discharged gas flowing through the discharge flow path is transferable to the group of high pressure tanks.

2. The high pressure tank system according to claim 1, wherein:
an axis line of each of the plurality of high pressure tanks extends in a first direction that is directed along a horizontal direction;
the plurality of high pressure tanks are arranged in a second direction that is perpendicular to the first direction and directed along the horizontal direction;
the accommodation unit comprises a side wall portion configured to cover the group of high pressure tanks from the second direction; and
the side wall portion includes the discharge flow path.

3. The high pressure tank system according to claim 2, wherein the side wall portion and the discharge flow path extend along the first direction.

4. The high pressure tank system according to claim 3, wherein the discharge flow path is disposed in an interior of the side wall portion.

5. The high pressure tank system according to claim 4, wherein:
a through hole extending along the first direction is formed in the side wall portion; and
at least a portion of the discharge flow path is formed by the through hole.

6. The high pressure tank system according to claim 2, wherein the side wall portion is provided with a mounting member configured to mount the accommodation unit on a vehicle body.

7. A high pressure tank system, comprising:
a group of high pressure tanks comprising a plurality of high pressure tanks each having a cylindrical shape, the high pressure tanks being configured to be filled with a fuel gas that is supplied to a motive power source;
an accommodation unit configured to accommodate the group of high pressure tanks; and
a discharge flow path through which a discharged gas that is guided from the motive power source flows,
wherein:
the discharge flow path is disposed in a manner so that heat of the discharged gas flowing through the discharge flow path is transferable to the group of high pressure tanks;
an axis line of each of the plurality of high pressure tanks extends in a first direction that is directed along a
the plurality of high pressure tanks are arranged in a second direction that is perpendicular to the first direction and directed along the horizontal direction;
the accommodation unit comprises a side wall portion configured to cover the group of high pressure tanks from the second direction;
the side wall portion is provided with the discharge flow path; and
the group of high pressure tanks comprises a first group of high pressure tanks and a second group of high pressure tanks that are disposed mutually adjacent to each other in an upward/downward direction,
wherein:
the side wall portion comprises:
a first portion configured to cover the first group of high pressure tanks from the second direction; and
a second portion adjacent to the first portion in the upward/downward direction, and configured to cover the second group of high pressure tanks from the second direction, and
wherein:
the second portion includes the discharge flow path; and
the first portion projects out with respect to the second portion toward an opposite side to the group of high pressure tanks.

8. A high pressure tank system, comprising:
a group of high pressure tanks comprising a plurality of high pressure tanks each having a cylindrical shape, the high pressure tanks being configured to be filled with a fuel gas that is supplied to a motive power source;
an accommodation unit configured to accommodate the group of high pressure tanks; and
a discharge flow path through which a discharged gas that is guided from the motive power source flows,
wherein:
the discharge flow path is disposed in a manner so that heat of the discharged gas flowing through the discharge flow path is transferable to the group of high pressure tanks, an axis line of each of the plurality of high pressure tanks extends in a first direction that is directed along a horizontal direction;
the plurality of high pressure tanks are arranged in a second direction that is perpendicular to the first direction and directed along the horizontal direction;
the discharge flow path comprises a lower-side discharge flow path disposed downwardly of the group of high pressure tanks; and
a lower-side heat insulating member is disposed between the group of high pressure tanks and the lower-side discharge flow path.

9. The high pressure tank system according to claim 8, wherein a height of the lower-side discharge flow path along an upward/downward direction is smaller than a width of the lower-side discharge flow path along the second direction.

10. The high pressure tank system according to claim 8, wherein the accommodation unit comprises a lower cover member disposed downwardly of the lower-side discharge flow path.

11. The high pressure tank system according to claim 10, wherein:
the accommodation unit comprises a side wall portion configured to cover the group of high pressure tanks from the second direction;
the lower cover member is mounted to the side wall portion; and
the side wall portion is provided with a mounting member configured to mount the accommodation unit on a vehicle body.

12. The high pressure tank system according to claim 8, wherein:
the lower-side discharge flow path comprises a first lower-side discharge flow path and a second lower-side discharge flow path which are disposed mutually adjacent to each other in the second direction; and
a proportion of liquid water contained in the discharged gas flowing through the second lower-side discharge flow path is smaller than a proportion of liquid water contained in the discharged gas flowing through the first lower-side discharge flow path.

13. A high pressure tank system, comprising:
a group of high pressure tanks comprising a plurality of high pressure tanks each having a cylindrical shape, the high pressure tanks being configured to be filled with a fuel gas that is supplied to a motive power source;
an accommodation unit configured to accommodate the group of high pressure tanks; and
a discharge flow path through which a discharged gas that is guided from the motive power source flows,
wherein:
the discharge flow path is disposed in a manner so that heat of the discharged gas flowing through the discharge flow path is transferable to the group of high pressure tanks;
an axis line of each of the plurality of high pressure tanks extends in a first direction that is directed along a horizontal direction;
the plurality of high pressure tanks are arranged in a second direction that is perpendicular to the first direction and directed along the horizontal direction;
the discharge flow path comprises an upper-side discharge flow path disposed upwardly of the group of high pressure tanks; and
an upper-side heat insulating member is disposed between the group of high pressure tanks and the upper-side discharge flow path.

14. The high pressure tank system according to claim 13, wherein a height of the upper-side discharge flow path along an upward/downward direction is smaller than a width of the upper-side discharge flow path along the second direction.

15. The high pressure tank system according to claim 14, wherein the accommodation unit comprises a lower cover member disposed downwardly of the group of high pressure tanks.

16. The high pressure tank system according to claim 15, wherein:
the accommodation unit comprises a side wall portion configured to cover the group of high pressure tanks from the second direction;
the lower cover member is mounted to the side wall portion; and
the side wall portion is provided with a mounting member configured to mount the accommodation unit on a vehicle body.

17. The high pressure tank system according to claim 1, wherein:
the motive power source comprises a fuel cell or a hydrogen engine; and
the fuel gas is a hydrogen gas.

18. A moving body comprising:
the high pressure tank system according to claim 1; and
the motive power source.

19. A moving body comprising:
the high pressure tank system according to claim 7; and
the motive power source.

20. A moving body comprising:
the high pressure tank system according to claim 8; and
the motive power source.
